(19) United States
(12) Patent Application Publication
(10) Pub. No.: US 2026/0181692 A1
(43) Pub. Date: Jun. 25, 2026

(54) AMBIENT POWER WIFI BACKSCATTERING READ PROTOCOL AND MEDIUM PROTECTION

(71) Applicant: NXP USA, Inc., AUSTIN, TX (US)

(72) Inventors: Rui Cao, Sunnyvale, CA (US); Franz Amtmann, Graz (AT); Liwen Chu, San Ramon, CA (US); Hongyuan Zhang, Fremont, CA (US)

(21) Appl. No.: 19/425,872

(22) Filed: Dec. 18, 2025

Related U.S. Application Data
(60) Provisional application No. 63/736,466, filed on Dec. 19, 2024.

(51) Int. Cl. H04W 74/0816; H04L 5/00; H04W 72/0446; H04W 74/0833; H04W 84/12

(52) U.S. Cl. CPC H04W 74/0816; H04L 5/0055; H04W 72/0446; H04W 74/0833; H04W 84/12

(57) ABSTRACT

Methods and apparatus are provided for communicating with one or more ambient power (AMP) tag devices by an AMP compliant WiFi device. A method includes transmitting, by the AMP compliant WiFi device, a CTS-to-Self (CTS2Self) frame that includes a duration field carrying a value indicating a wireless medium reservation duration. The method further includes transmitting (by the WiFi device) a first command and receiving, in response to the first command, a reply from a tag device. In this method, the WiFi device further transmits a CF-End frame prior to the end of the wireless medium reservation duration, to release a remaining portion of the wireless medium reservation duration. In another example, a tag reading protocol utilizing an Extension command and multiple transmission opportunities (TXOPs) is described.

### CROSS REFERENCE TO RELATED APPLICATIONS

The present U.S. Utility Patent Application claims priority pursuant to 35 U.S.C. § 119(e) to U.S. Provisional Application No. 63/736,466, entitled “AMBIENT POWER WIFI BACKSCATTERING READ PROTOCOL AND MEDIUM PROTECTION”, filed Dec. 19, 2024, the contents of which is hereby incorporated herein by reference in its entirety and made part of the present U.S. Utility Patent Application for all purposes.

### TECHNICAL FIELD

This disclosure relates generally to data communications and, more particularly, to methods and apparatus for ambient power WiFi communications.

### BACKGROUND

Existing Ultra-High Frequency Radio Frequency Identification (UHF RFID) standards, such as the Electronic Product Code Generation 2 standard (EPC Gen 2/ISO 18000-63), provide an air-interface protocol that defines how passive RFID tags and readers communicate through battery-less backscattering in the UHF band of ˜860-930 MHz. Ambient Power (AMP) communication is currently being discussed in the Institute of Electrical and Electronics Engineers (IEEE) Task Group bp for the 802.11.bp amendment to the 802.11 standard. AMP communication is intended to enable low power operation of AMP tag devices through battery-less backscattering in a 2.4 GHz range.

### BRIEF DESCRIPTION OF THE DRAWINGS

One or more embodiments will now be described by way of example only with reference to the accompanying drawings, in which:

FIG. 1 illustrates an example of an ambient power (AMP) communication system in accordance with embodiments of the present disclosure;

FIG. 2 illustrates an example of a tag reading protocol with medium protection in accordance with embodiments of the present disclosure;

FIG. 3 illustrates an example of a tag reading protocol utilizing multiple transmission opportunities (TXOPs) in accordance with one or more embodiments of the present disclosure;

FIG. 4 illustrates an example of a tag reading protocol utilizing an Extension command and multiple TXOPs in accordance with one or more embodiments of the present disclosure;

FIG. 5 illustrates another example of a tag reading protocol utilizing an Extension command in accordance with one or more embodiments of the present disclosure;

FIG. 6 illustrates an example of a single tag read sequence in accordance with one or more embodiments of the present disclosure;

FIG. 7 illustrates a multi-tag access sequence in accordance with embodiments of the present disclosure;

FIG. 8 illustrates an example of a tag read and delayed reply sequence in accordance with embodiments of the present disclosure;

FIG. 9A illustrates an example of a tag authentication sequence in accordance with embodiments of the present disclosure;

FIG. 9B illustrates an example of a tag write sequence in accordance with embodiments of the present disclosure;

FIG. 10 illustrates an example of an RF front end architecture of an AMP tag;

FIG. 11 illustrates an example of an AMP tag RF front end architecture including a differential energy detector; and

FIG. 12 is a flow chart illustrating an example method for reading a tag using medium protection in accordance with one or more embodiments of the present disclosure.

### DETAILED DESCRIPTION

The various implementations described in the following description relate generally to tag read/access protocols and commands associated with Ambient Power (AMP) communications between an AMP WiFi device and an AMP tag device(s). More particularly, innovative read protocols and medium protection mechanisms are described to support ambient backscatter communications, coexistence mechanisms, wireless power transfer/RF energy harvesting, multiple data communication modes (e.g., a sub-1 GHz band communication mode and a 2.4 GHz band communication mode) and other features associated with the IEEE 802.11bp amendment to the IEEE 802.11 standard. Briefly, the 802.11bp amendment is intended to extend IEEE 802.11 MAC and PHY layers to support AMP stations (AMP STAs) that harvest energy for operation.

Embodiments disclosed herein are directed to methods and apparatus for communications between an AMP compliant WiFi device and one or more AMP tag devices in a manner that is able to co-exist with legacy WiFi devices and infrastructure of a WiFi network. In an example described more fully below, a method includes transmitting, by an AMP compliant WiFi device, a CTS-to-Self (CTS2Self) frame that includes a duration field carrying a value indicating a wireless medium reservation duration. The method further includes transmitting (by the WiFi device) a first command and receiving, in response to the first command, a reply from a tag device. In this method, the WiFi device further transmits a CF-End frame prior to the end of the wireless medium reservation duration, to release a remaining portion of the wireless medium reservation duration. In other examples, a tag reading protocol utilizing an Extension command and multiple transmission opportunities (TXOPs) are described.

As used herein, the term “non-legacy” may refer to physical layer protocol data unit (PPDU) formats and communication protocols conforming with the IEEE 802.11bn amendment to the IEEE 802.11 standard (also referred to as Ultra High Reliability or “UHR” or “Wi-Fi 8”) and/or the IEEE 802.11bp amendment to the IEEE 802.11 standard as well as future generations/amendments. In contrast, the term “legacy” may be used herein to refer to PPDU formats and communication protocols conforming to the IEEE 802.11be (also referred to as Extremely High Throughput or “EHT” or “Wi-Fi 7”) or IEEE 802.11ax (also referred to as High Efficiency or “HE” or “Wi-Fi 6/6E”) amendments to the IEEE 802.11 standard, or earlier generations of the IEEE 802.11 standard.

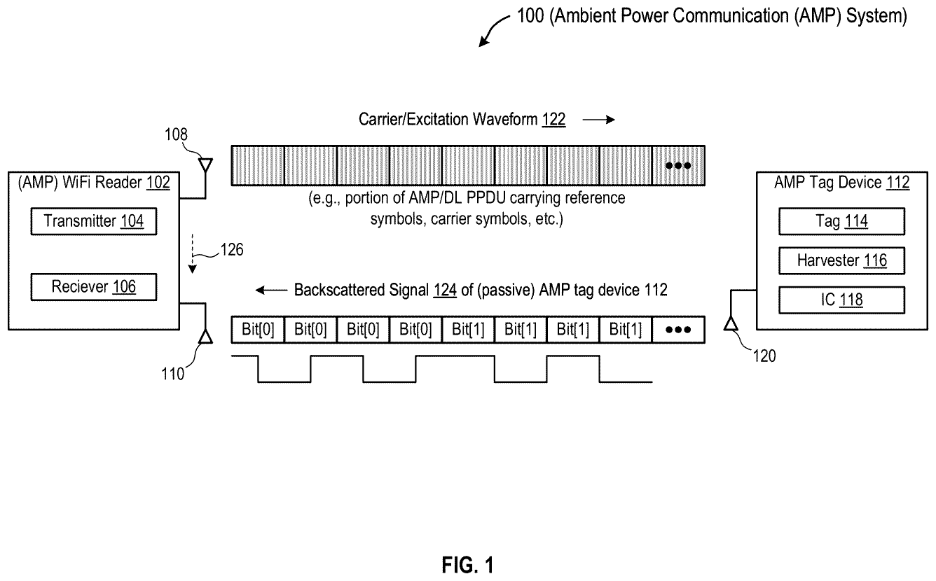

FIG. 1 illustrates an example of an ambient power (AMP) communication system 100 in accordance with embodiments of the present disclosure. The illustrated AMP communication system 100 includes an AMP tag device 112 and a WiFi reader 102 and that is AMP compliant and may operate to read (and in some cases write) data from/to the AMP tag device 112. The AMP tag device 112 and WiFi reader 102 may be implemented by one or more of analog circuitry, mixed-signal circuitry, memory circuitry, logic circuitry, and processing circuitry that executes code stored in a memory(ies) to perform disclosed functions on one or more integrated circuits.

The AMP tag device 112 may be a device compatible with the 802.11bp amendment to the IEEE 802.11 standard. In one or more embodiments, the AMP tag device 112 can be a battery-less backscattering tag device operable in one or more frequency sub-bands, such as sub- 1 GHz and 2.4 GHz (or general sub- 7 GHz) frequency bands, and have one or more antenna 120 for transmitting or receiving in the operating frequency band(s). The AMP tag device 112 is typically a low-cost device, and has an energy efficient design by using a low cost voltage controlled oscillator (VCO) with no crystal and phase lock loop (PLL). The AMP tag device 112 may also have an integrated circuit (IC) 118 to facilitate transmitting or receiving signals in the one or more frequency bands based on timing of the VCO. A received signal may indicate a request from the WiFi reader 102 to read or write data in a memory of the AMP tag device 112 (also referred to herein as tag 114) and a transmitted signal may indicate data stored in the tag 114 or a response to a write operation. The AMP tag device 112 may further include a harvester 116 which extracts power from a (energizing/excitation) waveform 122 transmitted by the AMP-compliant WiFi reader 102 and incident on the antenna 120 in order to operate the integrated circuit (IC) 118 to receive and transmit signals.

An AMP tag device 112 may include an AMP IoT device functioning as a sensor, monitor, actuator, etc. for various applications that may require low cost and maintenance-free/battery-less devices and/or small form factor devices. Such applications may include, for example, smart manufacturing, environmental sensing and monitoring (e.g., data center monitoring), asset management, smart home sensing and monitoring, smart agriculture applications, indoor positioning, smart power grid applications, food supply chain monitoring, etc. In operation, such devices should be backward compatible with existing WiFi signals and communications (e.g., 20 MHz channel bandwidths, symbol-based waveforms, and higher carrier frequencies (2.4 GHz, 5 GHz, 6 GHZ, etc.).

In one or more embodiments, the waveform 122 may be a carrier waveform or energizing (carrier) waveform on which the data transmitted by the WiFi reader 102 is modulated, and on which the AMP tag device 112 backscatters data by modulation (e.g., amplitude or phase modulation) to define the signals transmitted by the AMP tag device 112. To transmit and receive the signals, the WiFi reader 102 of this example includes a transmitter 104, receiver 106 and one or more antenna such as antenna 108 and antenna 110. The WiFi reader 102 may take the form of a smart phone, smart home hub, public transportation hotspot, dedicated reader device, etc., and be compatible with one or more legacy and/or non-legacy amendments to the IEEE 802.11 standard.

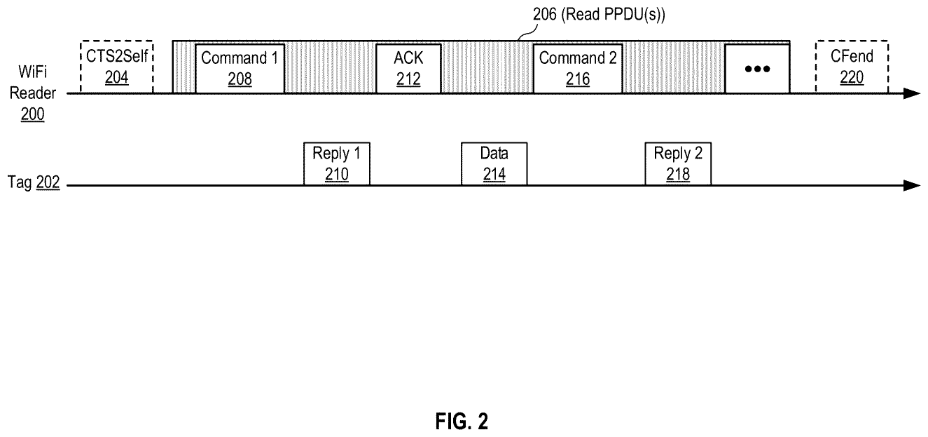

The WiFi reader 102 (also referred to herein as an AMP compliant WiFi device) of this example operates to transmit and receive WiFi signals in addition to signals transmitted for the operation of the AMP tag device 112. To achieve co-existence with other legacy WiFi devices (e.g., devices which do not support AMP communication), the WiFi reader 102 can be arranged to transmit the waveform 122 to the AMP tag device 112 in the form of an AMP physical layer protocol data unit (PPDU) (or “DL PPDU”) that includes a preamble having symbols that define a legacy WiFi preamble, e.g., a 802.11b preamble or legacy orthogonal frequency division multiplexed (OFDM) preamble (e.g., 802.11g/n/ac/ax/be), and a payload/AMP portion of the PPDU. By including the legacy preamble, the AMP PPDU is configured to allow other WiFi readers or legacy WiFi devices (not shown and not AMP compliant) to be able to decode the legacy preamble of the AMP PPDU and backoff from transmitting for the duration of the AMP PPDU (as indicated by the preamble) so as not to interfere with AMP communication between the WiFi reader 102 and the AMP tag device 112. In other examples, such as described in conjunction with FIG. 2, the WiFi reader 102 can be arranged to transmit a CTS-to-Self (CTS2Self) frame (e.g., at the beginning of a read sequence of AMP PPDUs) that includes a duration field carrying a value indicating a wireless medium reservation duration for the WiFi reader 102.

In one or more embodiments, the WiFi reader 102 may read data from the tag 116 or write data to the tag 116 by transmitting one or more AMP PPDUs. An AMP PPDU transmitted as the waveform 122 is incident on the antenna 120 of the AMP tag device 112. For passive AMP tag devices 112 that rely on backscattered communications, the harvester 116 of the AMP tag device 112 may harvest power from the waveform 122 defining the AMP PPDU to power the IC 118 to receive and decode symbols in an AMP portion of the PPDU which is in the payload of the AMP PPDU. Based on the symbols that are decoded in the AMP PPDU, the IC 118 may cause the AMP tag device 112 perform a read or write operation and transmit a response. The AMP tag device 112 may transmit the response by a backscattering process which involves modulating a portion of the waveform 122 incident on the antenna 120 to generate a backscatter signal 124. The impedance of the antenna 120 may be modulated based on bits of the response to modulate an amount of incident RF energy and scatter the amount of incident energy on the antenna 120 to transmit bits of the response from the AMP tag device 112 to the WiFi reader 102 as backscattering. The response may be data stored in the tag 116 (e.g., an identifier associated with the tag, sensor measurement data, etc.) or a protocol compliant response control message. The WiFi reader 102 will then receive this backscatter signal 124. In some embodiments, the WiFi reader 102 may further send an acknowledgement to indicate the receipt of the response or uplink communication. Various examples of command sequences (e.g., of a read operation) are described more fully in conjunction with FIGS. 2-9B.

The modulation clock accuracy of AMP tag device 112 may be very limited, e.g., 100,000 parts per million (ppm) variation due to a low cost design. The ppm may be measure of a variation of modulation accuracy such as a 1 Hz change in frequency for every 1 MHz of frequency. Further, complexity associated with the reading of data may need to be addressed by the WiFi reader 102, which needs to resolve a large sampling frequency offset (SFO) of the VCO of the AMP tag device 112.

In one or more embodiments, the WiFi reader 102 may need to send a well-designed waveform 122 to define the AMP PPDU. The waveform 122 may be the carrier waveform with a repeated base waveform. In this manner, signal leakage 112 from transmit antenna 108 to receive antenna 110 due to antenna coupling can be removed and the backscattered signal received by the WiFi reader 102 is able to be decoded with better signal-to-interference-and-noise ratio (SINR). The antenna coupling may be leakage of a signal transmitted by the transmitter 104 and received at the receiver 106. The waveform 122 may have defined design criteria such as a low peak to average power ratio (PAPR) to enable higher transmit power and better receive signal-to-noise ratio, a low power fluctuation for a duration of every symbol for which On-Off keying (OOK) modulation is applied for backscattering, and small spectral leakage due to the OOK. In an example, for 250 kbps OOK with Manchester encoding, a symbol duration is 2 us, while for 1 Mbps OOK with Manchester encoding, a symbol duration is 0.5 us. The OOK with Manchester encoding is a method of transmitting data where the waveform 122 is either on or off to represent a ‘1’ or ‘0’ bit, and the Manchester encoding ensures a transition occurs at the start of each bit period, aiding clock recovery and data integrity.

Signal leakage 126 may have a relatively high power and the same timing as the waveform 122, and the backscatter signal 124 received at the receiver 106 of the WiFi reader 102 may be masked by the signal leakage 126 which typically has a higher power. The WiFi reader 102 needs to remove this signal leakage 126 from a received signal at the receiver 106 to recover the backscatter signal 124 using a leakage estimation and removal process. Many approaches for removing this signal leakage 126 are possible.

In one or more embodiments, a leakage in an Nth symbol of the AMP PPDU that is received (where N is an integer) may be removed by subtracting a waveform of the N−1th symbol that is already received from a waveform of the Nth symbol. The differencing may reduce the signal leakage 126 but could result in destroying the Nth symbol modulation. In one or more embodiments, the WiFi reader 102 may transmit reference symbols in the AMP PPDU and determine leakage of the reference symbols between the transmitter 104 and the receiver 106. The reference symbols may be predefined symbols that represent a predefined data sequence. Then, the WiFi reader 102 may transmit subsequent carrier symbols which the AMP tag device 112 receives in the AMP PPDU. The AMP tag device 112 may receive the AMP PPDU and modulate data on a waveform of the carrier symbols based on backscattering to transmit data back to the WiFi reader 102, and the modulation parameters are determined based on control information in an AMP portion of the PPDU such as AMP data transmitted to the AMP tag device 112 which also includes a synchronization pattern and the reference symbols in some embodiments. The reference symbols may have a same format and content as the carrier symbols except for some phase or polarity differences, and the AMP tag device 112 does not backscatter any data within the duration of the reference symbols to allow for accurate signal leakage 126 determination. In some embodiments, the AMP tag device 112 may backscatter data bits to the WiFi reader 102 a predetermined time after sending the carrier symbols to allow for the WiFi reader 102 to estimate the signal leakage 126 based on the carrier symbols received during the non-backscattering time by the receiver 106. The WiFi reader 102 may receive the combined signal leakage 126 and backscattering signal 124 and then subtract the estimated signal leakage 126 based on reference symbols from the received signal to remove the signal leakage 126 and recover the backscatter signal 124 without the signal leakage 126.

In one or more embodiments, the WiFi reader 102 may send reference symbols periodically in the AMP PPDU and instruct the AMP tag device 112 to skip performing a backscattering every N reference symbols for the WiFi reader 102 to determine the signal leakage 126. The estimation process may include estimating the reference symbols which are received based on the transmitted reference symbols to estimate the signal leakage 126. The WiFi reader 102 may then subtract, at the receiver 106, the estimated signal leakage 126 based on the reference symbols from a received signal to recover the backscatter signal 124 and remove the signal leakage 126. The periodic sending of the reference symbols or determining the signal leakage 126 allows for improving the signal leakage 126 estimation and recovery of the backscattered signal with higher signal-to-noise ratio.

In one or more embodiments, the portion of the waveform 122 that defines the reference symbols associated with leakage estimation and the carrier symbols that are backscattered may not be simple repeated symbols that cause a spectrum spike and violate transmit requirements. The portion of the waveform 122 may also be a known waveform that is received at the receiver 106 for signal leakage 126 estimation. The phase or polarity on the portion of the waveform 122 for signal leakage 126 estimation may need to be removed to perform the carrier symbol leakage estimation. In one or more embodiments, the portion of the waveform 122 may be an existing WiFi single-carrier waveform, e.g., as defined by IEEE 802.11b. The receiver 106 may need to remove any modulation (e.g., differential binary phase shift keying (DBPSK)) of 802.11b from the reference symbol portion of the waveform 122, estimate the leakage signal of the reference symbols, and regenerate carrier symbols with modulation recovered for signal leakage 126 removal. As a result, a waveform of the regenerated carrier symbols is subtracted from a received signal at the receiver 106 to recover the backscattered signal 124 resulting from backscattering a waveform of carrier symbols in the AMP PPDU for signal leakage 126 removal.

While the foregoing description relates generally to backscattered communications, various methodologies described herein are likewise applicable to non-backscattered communications, such as those involving active or battery-powered tag devices that do not require (or only periodically require) an energizing waveform.

In the following examples, various medium protection mechanisms are described to protect a tag read event(s). In addition, a novel Extension command is described to extend a read event/command sequence over multiple TXOPS. For a multi-tag read sequence, a probability based random access scheme is further described.

With respect to TXOP protection, a tag reading protocol can include sending a CTS2Self frame before a read event to protect an entire sequence of transmissions. In this example, the WiFi reader has the flexibility to determine the combination of commands to be used. In another example, a WiFi reader may determine to use relatively smaller PPDUs for a command sequence. In this example, each PPDU can perform one function and the PPDUs may be separated by a spacing that is equal to or less than a short interframe space (SIFS). In further examples, a WiFi reader may perform a read event (e.g., an inventory round) using multiple TXOPs. Under this approach, a WiFi reader that is reading a particular (AMP) tag may transmit an Extension frame as the last command in a TXOP to indicate that it will access the same tag again in the next TXOP, and the tag retains a status flag/bit in persistent memory such that it can reply to the next command without performing a tag ID reply procedure to continue the read event. In addition, the WiFi reader may transmit an excitation field at the beginning of the next TXOP to wake up the tag.

FIG. 2 illustrates an example of a tag reading protocol with medium protection in accordance with embodiments of the present disclosure. In the illustrated example, a WiFi reader 200 may first transmit a medium reservation frame (such as a CTS2Self frame 204) at the beginning of a read sequence of AMP PPDUs in order to protect the entire frame exchange sequence. In this example, the medium reservation frame includes a duration field carrying a value indicating a wireless medium reservation duration for performing the read sequence. The duration of the read sequence can be dynamic depending on an unknown number of recipient tags in the field and the error recovery mechanism that is utilized (e.g., for resolving collisions in a multi-tag environment), and the medium reservation duration can be conservatively set based on an expected number of tags to be read. The WiFi reader 200 next transmits one or more read PPDUs 206 for receipt by a (AMP) tag 202 and, in some embodiments, additional tags within operating range of the WiFi reader 200. In this example, the illustrated read PPDU 206 includes a first command 208 that solicits a first reply 210 (e.g., a tag identifier value) from the tag 202. The WiFi reader 200 acknowledges the first reply 210 by transmitting ACK frame (or “ACK”) 212, and the tag 202 performs data backscattering to provide solicited data 214 stored in and/or collected by the tag 202. The data 214 can include various content such as data corresponding to an EPC code, collected sensor data, etc.

In the illustrated example, the read sequence continues and WiFi reader 200 transmits a second command 216 and receives a second reply 218 from the tag 202. In this example, in addition to sending control information/commands to the tag 202, the read PPDU 206 may serve as the energizing carrier waveform for use by tag(s) 202 in generating the first reply 210, data 214 and second reply 218. The read sequence may include addition commands and responses as necessary to retrieve data from tag 202 and/or additional tags. Following completion of the read sequence, the WiFi reader 200 may transmit a CFend frame 220 to release a remaining portion of the wireless medium reservation duration.

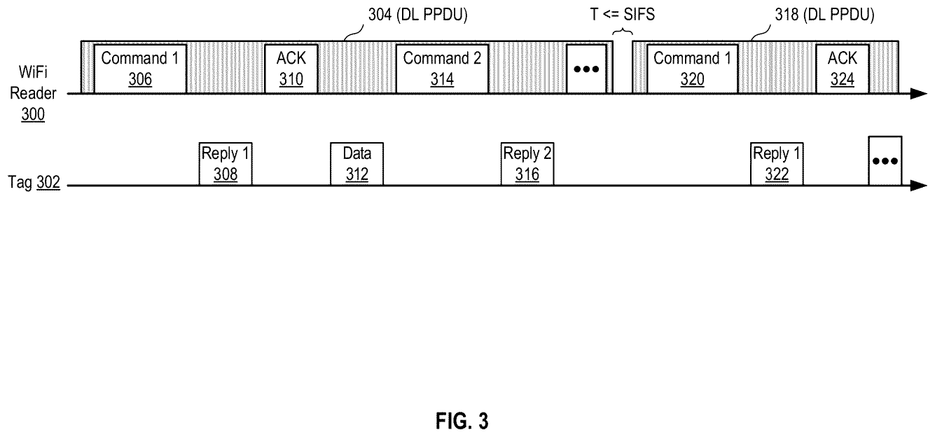

FIG. 3 illustrates an example of a tag reading protocol utilizing multiple transmission opportunities (TXOPs) in accordance with one or more embodiments of the present disclosure. In this example, a WiFi reader 300 may determine to generate and burst transmit relatively smaller AMP downlink (DL) PPDUs for a command sequence. Each DL PPDU can perform a specific function (e.g., read a single tag, authenticate a tag, etc.) and the PPDUs may be separated by a spacing that is equal to or less than a less than a short interframe space (SIFS).

In the illustrated tag reading protocol, the WiFi reader 300 transmits a first DL PPDU 304 that includes a first command 306 that solicits a first reply 308 (e.g., a backscattered reply including an RN16 value) from tag 302. The WiFi reader 300 acknowledges the first reply 308 with an ACK 310, and the tag 302 subsequently provides solicited data 312. The data 312 can include various content such as an EPC code, collected sensor data, etc. In this example, the WiFi reader 300 further transmits a second command 314 during the DL PPDU 304, and receives a second reply 316 from tag 302 (or another tag). Additional communications between the WiFi reader 300 and tag 302 prior to the end of the first DL PPDU 304.

The WiFi reader 300 next transmits a second DL PPDU 318. In the illustrated example, the first DL PPDU 304 and the second DL PPDU begins within a predetermined time period following the first TXOP. In this example, the predetermined time period is equal to or less than a short interframe space (SIFS), such as a SIFS defined in the IEEE 802.11 standard. The DL PPDU 318 includes a first command 320 and a responsive first reply 322 from tag 302. The DL PPDU 318 further includes an ACK 324 from the WiFi reader 300 and further backscattered communications from the tag 302.

In an example, prior to transmitting the DL PPDU 304 the WiFi reader 300 may transmit/pre-append an 802.11 CTSelf frame (not separately illustrated) in order to reserve the wireless medium. In another example, a PHY preamble is transmitted at the beginning of the DL PPDU 304 and/or the DL PPDU 318.

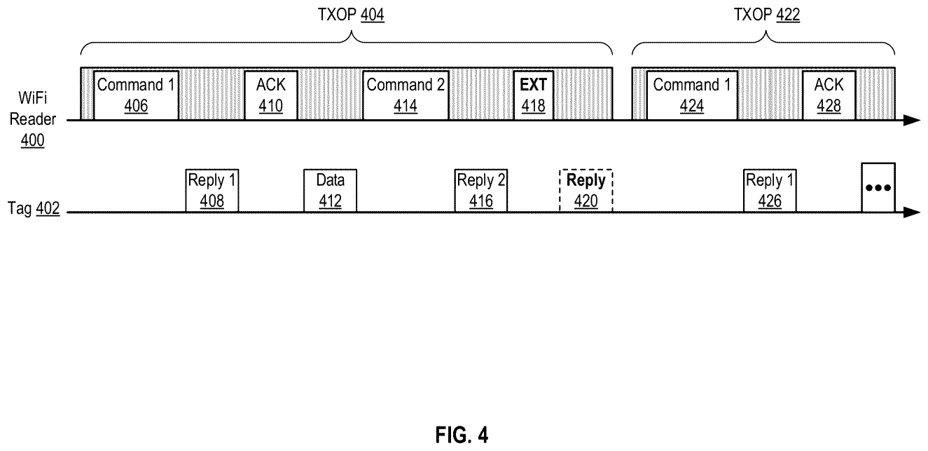

FIG. 4 illustrates an example of a tag reading protocol utilizing an Extension command and multiple TXOPs in accordance with one or more embodiments of the present disclosure. In this example, a WiFi reader 400 may perform a read event (e.g., an inventory round) using multiple TXOPs. When reading a particular (AMP) tag 402, the WiFi reader 400 may transmit a newly-defined Extension frame at the end of a read PPDU to indicate that it will read the same tag again in the next TXOP, and the tag retains a status/bit in persistent memory such that it can reply to the next command without performing a tag ID reply procedure to continue the read event. In addition, the WiFi reader may transmit an excitation field at the beginning of the next TXOP to wake up the tag.

In the illustrated tag reading protocol, during a first transmission opportunity (TXOP) 404 the WiFi reader 400 transmits a DL PPDU that includes a first command 406 that solicits a first reply 408 (e.g., an RN16 value or other tag identifier) from tag 402. The WiFi reader 400 acknowledges the first reply 408 with an ACK 410, and the tag 402 subsequently provides solicited data 412. The data 412 can include various content such as an data corresponding to an EPC code, collected sensor data, etc. In this example, the WiFi reader 400 further transmits a second command 414 during the TXOP 404, and receives a second reply 416 from tag 402 (or another tag). Prior to the end of the first TXOP 404, the WiFi reader 400 of this example transmits an Extension command 418 to indicate to the tag 402 that it should be prepared to reply to the next read event in a following TXOP 422. The Extension command 418 thereby enables efficient reading of tag data through multiple read events. In an example, the tag 402 may transmit a confirmation (reply 420) in response to the Extension command 418.

The WiFi reader 400 next transmits a second DL PPDU during a second TXOP 422 (e.g., following a predetermined time period that is equal to or less than a SIFS after the first TXOP 404). In the illustrated example, the second DL PPDU includes a command 424 from the WiFi reader 400, a responsive (backscattered) reply 426 from tag 302, and an ACK 428 from the WiFi reader 400, and (optionally) further communications between the WiFi reader 400 and the tag 402.

In the example of FIG. 4, prior to transmitting the TXOP 404 the WiFi reader 400 may transmit/pre-append an 802.11 CTSelf frame (not separately illustrated) in order to reserve the wireless medium. In another example, a PHY preamble is transmitted at the beginning of the TXOP 404 and/or the TXOP 422.

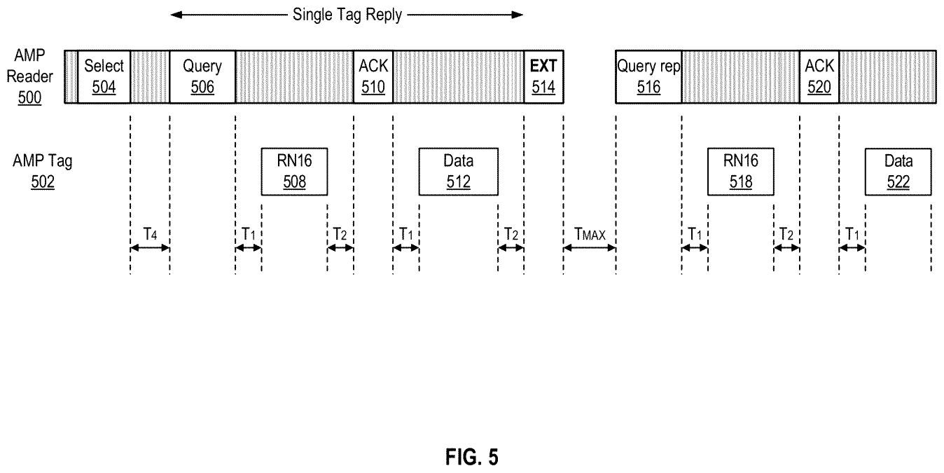

FIG. 5 illustrates another example of a tag reading protocol utilizing an Extension command (or “Ext frame”) in accordance with one or more embodiments of the present disclosure. As noted, the Extension command is a newly-defined command that operates to efficiently extend a read event for an AMP tag into a subsequent TXOP. In an example, after an AMP tag ID has been identified by an AMP reader 500, the Extension command can be inserted into the middle of any following read sequence to separate the read sequence into a subsequent TXOP(s).

In the illustrated example, the AMP reader 500 first performs an inventory/singulation process to identify a particular AMP tag to read. This process may begin with a Select command 504 that functions to filter the tag population based on memory content (e.g., Electronic Product Code, Tag Identifier, User/application-specific data, etc.) and define which AMP should participate in a subsequent inventory round. For example, the AMP reader 500 may select only container tags in a mixed population of tags for a targeted inventory procedure.

The AMP reader 500 of this example next transmits a Query command 506 following a time T4 (e.g., an amount of time sufficient to allow processing of the Select command 504 by recipient tags). In an example, the Query command 506 functions to initiate an inventory process, and may specify a session and Q parameter that determines a number of slots for a slotted ALOHA anti-collision algorithm. In response to the Query command 506, an AMP tag 502 transmits an RN16 value 508 following a time T1 (which may be shorter than time T4). In this example, the RN16 value 508 is a 16-bit random number generated by AMP tag 502, and is used by the AMP reader 500 as a temporary identifier in the anti-collision process to assist the AMP reader 500 in distinguishing between multiple tags (e.g., before a tag's full Electronic Product Code (EPC) or other identifier is transmitted). Following a time T2, the AMP reader 500 of this example further transmits an ACK frame 510. The ACK frame 510 acknowledges the RN16 value 508 with a matching packet to confirm communication with AMP tag 502 and prompt it to send further data (e.g., an EPC or other data).

In response to the ACK frame 510, the AMP tag 502 transmits (e.g., via backscattering) a data frame 512 following a time T1. The data frame 512 may have various content. For example, a code may be communicated by the AMP reader 500 to specify the requested data to be included in data frame 512. In the illustrated protocol, the AMP reader 500 transmits an Extension command 514 to extend the read event into a second/subsequent TXOP. Although not separately illustrated, the AMP tag may reply to the Extension command 514 to confirm reception of the Extension command.

In the illustrated example, the second TXOP begins following a time Tmax, which can be defined such that it is no longer than a predetermined threshold (e.g., 10 ms, 100 ms, 1 second, etc.). At the beginning of the second TXOP, the AMP reader 500 transmits a Query rep command 516. In an example, the Query rep command 516 advances a slot counter for recipient tags to facilitate singulation. In response to the Query rep command 516, the AMP tag 502 (or other AMP tag) responds with an RN16 value 518, and the AMP reader 500 transmits a responsive ACK frame 520. The AMP tag 502 (or other tag) then transmits a data frame 522 including requested data. Additional Extension commands (not separately illustrated) may be transmitted by the AMP reader 500 to further extend the read event into additional TXOPs.

In general, an AMP DL PPDU as described herein can serve various types of AMP tags and enable multiple functions. For example, for AMP-assisted WiFi devices (e.g., IoT devices) the AMP DL PPDU can provide a wakeup function. For AMP-only active STAs, the AMP DL PPDU can be used for wakeup and to provide downlink control frames. For backscattering AMP tags (or AMP STAs), the AMP DL PPDU can be used for wakeup, to provide downlink control frames, and to provide an uplink carrier waveform for energy harvesting.

Various of protocols described herein can support all three categories of AMP devices. Each category of AMP devices may have different hardware design limitations. For example, AMP-only active STAs can support 1000 Hz ppm, up to a 8 MHz clock rate, and a link budget of 90 dB. Backscattering AMP tags may support 10Kppm, up to a 2 MHz clock rate, and a link budget of 30 dB. Wakeup only AMP devices may have similar capabilities as active STAs/tags, including a link budget of 90 dB. Accordingly, multiple SYNC patterns of an AMP DL SYNC field transmitted by an AMP compliant WiFi device can be defined to support different types of AMP STAs.

An AMP tag that supports backscattering may operate with an excitation power of about −20dBm, and the signal-to-noise ratio (SNR) is relatively high. In addition to sub-1 GHz and 2.4 GHz operation under AMP, such an ambient powered tag (e.g., a dual-function or multi-function AMP tag) may further support UHF RFID functions. A dual/multi-function ambient powered tag with dual band support may not be able to readily distinguish different carriers in the radio frequency (RF). As such, an AMP DL SYNC field may be a single SYNC sequence utilized by an AMP tag device to distinguish between sub-1 GHz and 2.4 GHz backscattering operation and, in some examples, further distinguish a UHF RFID preamble.

In some embodiments, an AMP reader and dual-mode AMP tag may leverage an EPC Gen2 logical interface for read events (e.g., an inventory round). For example, an AMP compliant system may, down select certain EPC Gen2 sequences for AMP operation, add commands such as the Extension command, and define corresponding parameters based on WiFi hardware capabilities. Further, sequences such as read sequences may be embedded in an AMP DL PPDU format.

In the following detailed description, varying tag access (or read) sequences are defined. Such functional sequences/protocols include (1) a single tag access sequence, (2) a multi-tag access sequence (e.g., to support multi-tag collision resolution), (3) a tag content read sequence, and (4) a delayed tag reply sequence.

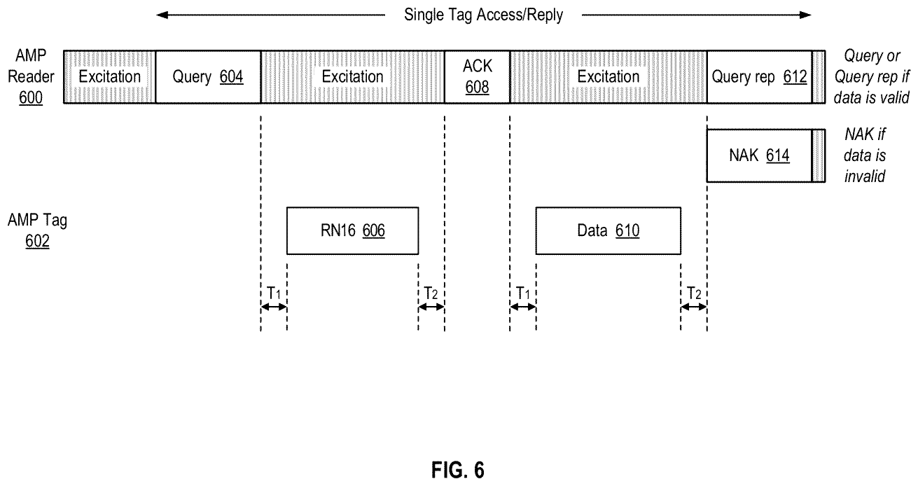

FIG. 6 illustrates an example of a single tag read sequence in accordance with one or more embodiments of the present disclosure. The single tag read sequence may be utilized, for example, for reading a tag a close range or in other situations where a single tag is deployed within an operating range of an AMP reader. In the illustrated example, an AMP reader 600 transmits (e.g., following an excitation period) a Query command 604. In an example, the AMP reader 600 indicates in the Query command 604 that the subject sequence is single tag reply sequence, and that no random access procedure is allowed or required. In response to the Query command 604, an AMP tag 602 transmits an RN16 value 606 following a time T1. Following a time T2, the AMP reader 600 of this example further transmits an ACK frame 608. The ACK frame 608 acknowledges the RN16 value 606 with a matching packet to confirm communication with AMP tag 602 and prompt it to send further data (e.g., an EPC or other data).

In response to the ACK frame 608, the AMP tag 602 transmits (e.g., via backscattering) a data frame 610 following a time T1. The data frame 610 may have various content (e.g., corresponding to a code communicated by the AMP reader 600) and include a CRC value for error detection. In the illustrated protocol, if the data received from data frame 610 is valid, the AMP reader 600 transmits a Query rep command 612 (or, alternatively, a Query command). If the received data is invalid, the AMP reader 600 instead transmits a NAK 614. In an example, the NAK 614 instructs the AMP tag 602 to return to a previous state or await further commands.

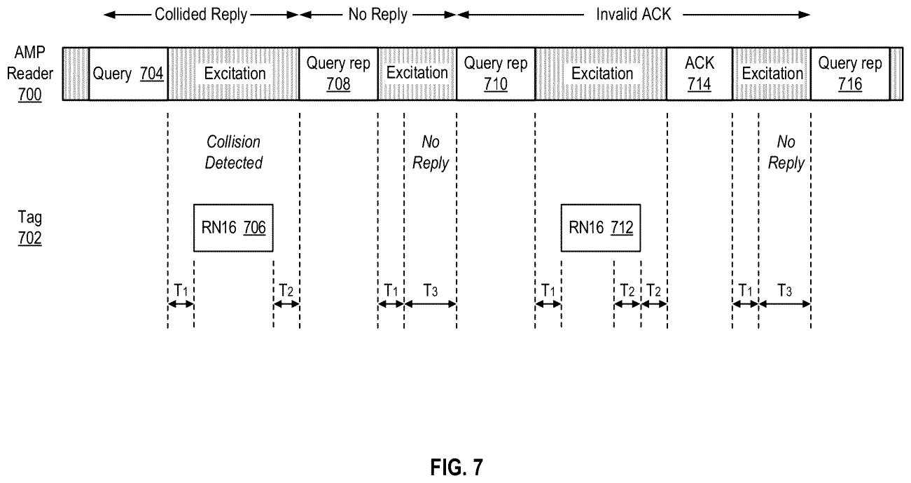

FIG. 7 illustrates a multi-tag access sequence in accordance with embodiments of the present disclosure. The multi-tag access sequence may be utilized, for example, when there is more than one tag within the operating range of an AMP reader 700 or in the event a prior single tag access sequence has failed. In this example, the multi-tag access sequence addresses tag reply collisions and missing tag replies. In another example, a single tag access sequence is performed after a (valid) RN16 value is received from a tag.

In the illustrated example, an AMP reader 700 may budget sufficient time in a DL PPDU to accommodate the number of tags from which responses are expected (e.g., a maximum of 8 tags). For each Query or Query rep command received by a tag, the tag can decide whether or not to reply based on a random algorithm. In a first example, the tag will reply based on a random probability (e.g., 1/N) indicated by the Query (rep) command, which can be dependent on the total number of expected tags. In a second example, the tag will reply based on a random slot. For example, the tag can randomly draw a slot index after receiving a first Query command, and only reply to the Query (rep) command that has the same index. In this example, the AMP reader 700 indicates a total slot number N in the Query (rep) command.

In the example of FIG. 7, the AMP reader 700 transmits a Query command 704 (e.g., following an excitation period). In an example, the AMP reader 700 indicates in the Query command 704 that the subject sequence is a multi-tag reply sequence, and that random access is enabled. In response to the Query command 704, an AMP tag 702 transmits an RN16 value 706 following a time T1. In this example, the AMP reader 700 detects a collision between the transmission of the RN16 value 706 and one or more other transmissions. Following a time T2, the AMP reader 700 responds by transmitting a Query rep command 708. In this example, the AMP reader 700 does not receive a reply with a time T₁+T₃, and transmits a second Query rep command 710. In response, the AMP reader 700 receives an RN16 value 712 from tag 702 and transmits an ACK frame 714. In the illustrated example, the AMP reader 700 receives no reply to the ACK frame 714 from the tag 702 (invalid ACK) and transmits another Query rep command 716.

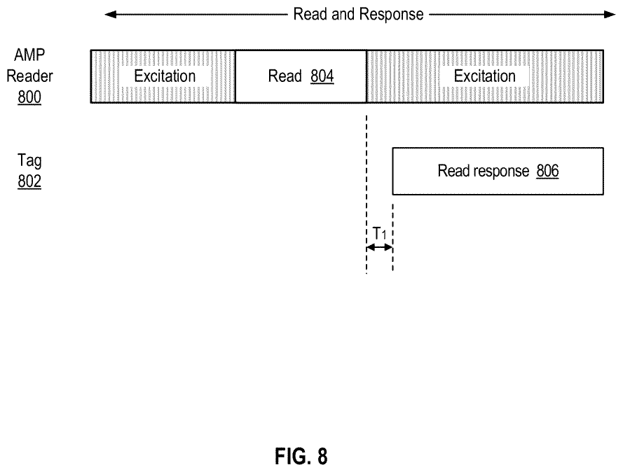

FIG. 8 illustrates an example of a tag read and delayed reply sequence in accordance with embodiments of the present disclosure. In the illustrated example, after obtaining a tag identifier (e.g., an EPC code) through a single tag or multi-tag reply sequence, the AMP reader 800 transmits a Read command 804 to tag 802. The Read command may be directed towards specific content in a tag memory (e.g., sensor data collected by the tag). Following a time T1, the tag 802 transmits (e.g., via backscattering) a read response 806. The illustrated sequence may be cascaded, for example, from a single tag or multi-tag access sequence.

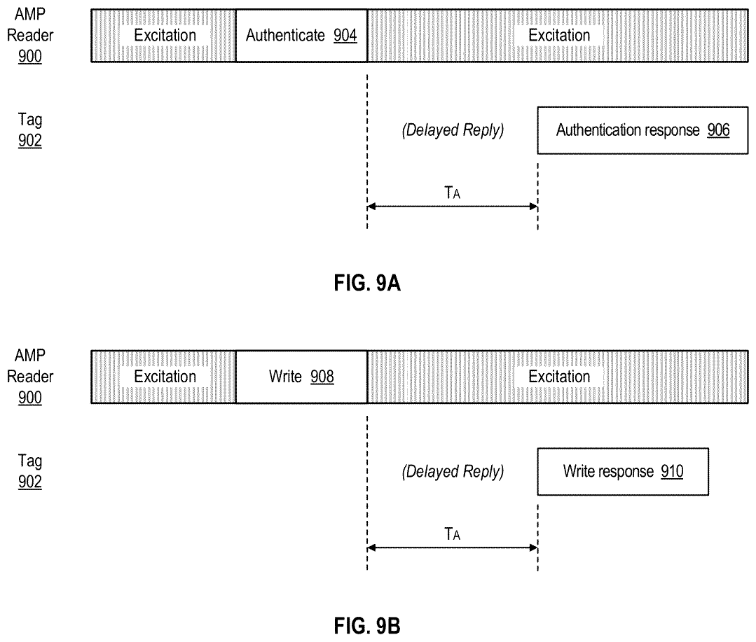

FIG. 9A illustrates an example of a tag authentication sequence in accordance with embodiments of the present disclosure. FIG. 9B illustrates an example of a tag write sequence in accordance with embodiments of the present disclosure. In these examples, after obtaining a tag identifier (e.g., through a single tag or multi-tag reply sequence), an AMP reader 900 can initiate/transmit delayed reply commands that provide a recipient tag an extended or relatively longer reply time T_{A} to transmit a reply (e.g., via backscattering). In addition, the AMP reader 900 can provide excitation energy during time T_{A} to enable the tag 802 to process the information before transmitting a reply. Examples of delayed reply commands may include Authenticate and Write commands (other use cases may also benefit from a delayed reply sequence).

In the example of FIG. 9A, the AMP reader 900 transmits an Authenticate command 904 for reception by tag 902. Following a delayed reply time T_{A}, the tag 902 transmits an authentication response 906. In the example of FIG. 9B, the AMP reader 900 transmits a Write command 908 (e.g., for sensor data calibration) for reception by tag 902. Following a delayed reply time T_{A}, the tag 902 transmits a write response 910. Following either of these examples, the AMP reader 900 may perform other sequences (e.g., for reading a tag or performing other functions) in the same TXOP/PPDU or in a separate TXOP/PPDU.

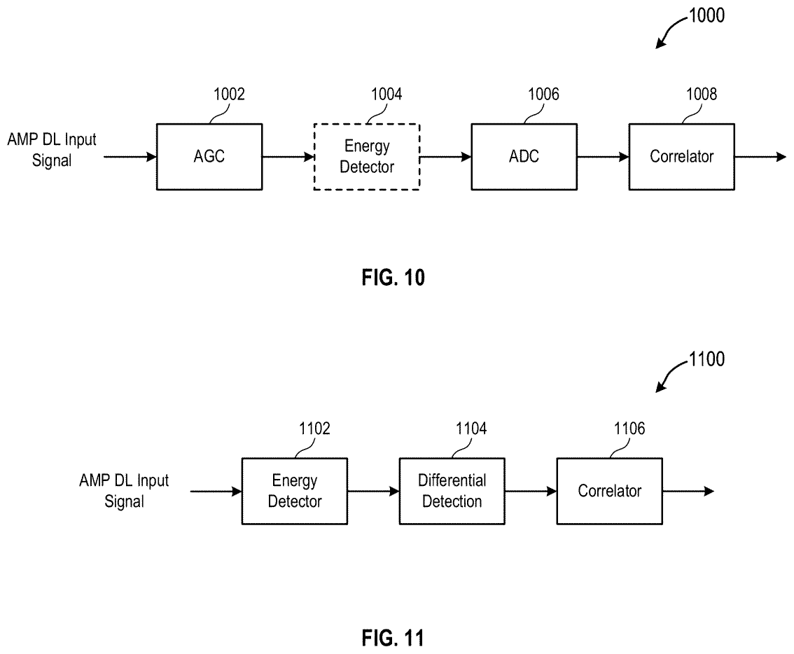

FIG. 10 illustrates an example of an RF front end architecture 1000 of an AMP non-backscattering tag. The illustrated RF front end architecture 1000 includes an Automatic Gain Control (AGC) circuitry 1002, an (optional) energy detector 1004, an Analog-to-Digital converter (ADC) 1006, and a correlator 1008. In this example, the AMP tag may be considered a “high-end” tag having front-end gain control and ADC sampling capabilities for performing ADC correlation-based SYNC detection.

FIG. 11 illustrates an example of an AMP tag RF front end architecture 1100 including an energy detector 1102, differential detection 1104, and a correlator 1106. In this example, the AMP tag may be considered a “low-end” tag having no front-end gain control functionality and only performing per-bit differential signal detection.

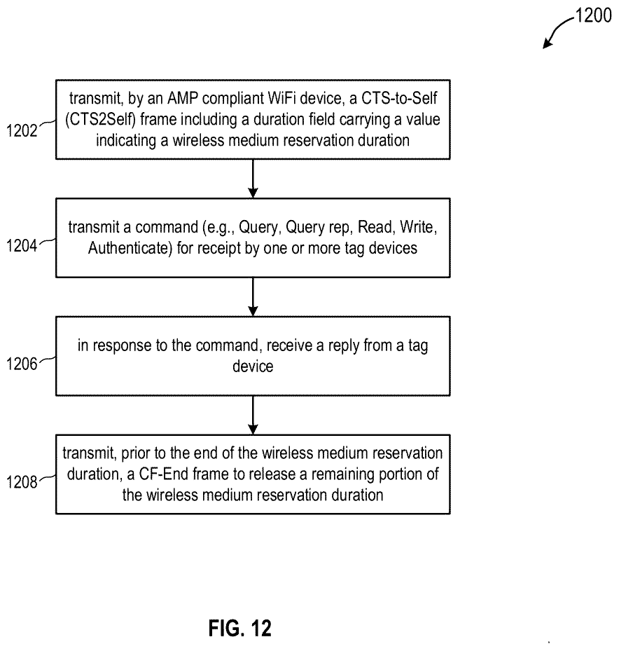

FIG. 12 is a flow chart illustrating an example method 1200 for reading a tag using medium protection in accordance with one or more embodiments of the present disclosure. The method 1200 can be performed by an AMP compliant WiFi device, such as the WiFi reader 102 described with reference to FIG. 1. The method 1200 may be utilized, for example, to perform AMP communications with a variety of active or passive AMP tag devices (e.g., in accordance with the 802.11bp amendment to the IEEE 802.11 standard).

The method begins at step 1202, where the WiFi device transmits a CTS-to-Self (CTS2Self) frame. In this example, the CTS2Self frame includes a duration field carrying a value that, with respect to other recipient WiFi devices, functions as a wireless medium reservation duration for the WiFi device in order to protect the wireless medium during subsequent communications with a tag device(s). The method continues at step 1204 where the WiFi device transmits a command (e.g., a Query command, a Query rep command, a Read command, a Write command, an Authenticate command, etc.) for receipt by one or more tag devices. The illustrated method continues at step 1206, where the WiFi device receives a reply from a tag device in response to the command. In various examples, the reply includes an identifier (e.g., an RN16 value) for the tag device or data stored in and/or collected by the tag device. The method continues at step 1208 where the WiFi device transmits, prior to the end of the wireless medium reservation duration, a CF-End frame to release a remaining portion of the wireless medium reservation duration.

While the innovative aspects of the present disclosure have been generally described in the context of the 802.11bp amendment to the IEEE 802.11 standard, a person having ordinary skill in the art will readily recognize that teachings and concepts herein may be applied to other wireless networks and standards including, for example, Long Term Evolution (LTE) standards and Bluetooth standards.

The innovative apparatus, frame formats, and methods illustrated in the figures and described herein enable ambient power (AMP) communications that are compatible with legacy WiFi devices and support AMP tag devices having varying communication capabilities. In an illustrative, non-limiting embodiment, a method for communicating with one or more tag devices by an ambient power (AMP) compliant WiFi device is provided. The method includes transmitting, by the WiFi device, a CTS-to-Self (CTS2Self) frame that includes a duration field carrying a value indicating a wireless medium reservation duration for the AMP compliant WiFi device. The method further includes transmitting a first command and receiving, in response, a reply from a tag device. The method further includes transmitting, prior to the end of the wireless medium reservation duration, a CF-End frame to release a remaining portion of the wireless medium reservation duration.

The method of this embodiment includes optional aspects. With one optional aspect, the first command is a Query command and the reply includes an identifier of the tag device. In another optional aspect, the method further includes transmitting, in response to receiving the reply from the tag device, an Acknowledge (ACK) frame and receiving data from the tag device in response to the ACK frame, wherein transmitting the CF-End frame follows receipt of the data. In yet another optional aspect, the identifier of the tag device is an RN16 value.

In another optional aspect, the Query command indicates a random access parameter for multi-tag access. In a further optional aspect, the random access parameter is a number of total slots. In yet another optional aspect, the tag device randomly selects a slot number of the number of total slots for transmitting the reply, and the reply includes an identifier of the tag device.

In a further optional aspect, the method further includes determining that the reply from the tag device is invalid or missing and, in response, transmitting a Query rep command. In another optional aspect, the method further includes receiving, in response to the Query rep command, an identifier of a second tag device, and determining that the identifier of the second tag device is valid. This optional aspect further includes transmitting a second command for receipt by the second tag device, wherein the second command solicits data from the second tag device.

In another optional aspect, the first command is a Write command or an Authenticate command. In yet another optional aspect, the method further includes transmitting a second command during the wireless medium reservation duration and receiving, in response, a reply from the second tag device. In a further optional aspect, the first command is transmitted during a first transmission opportunity (TXOP) and the method further includes transmitting the second command in a predetermined time period following the first TXOP. In another optional aspect, the predetermined time period is equal to or less than a short interframe space (SIFS), and the AMP compliant WiFi device does not transmit a second CTS2Self frame prior to transmitting the second command.

With another illustrative, non-limiting embodiment, a method for reading data from a tag device is provided. The method includes transmitting, by an ambient power (AMP) compliant WiFi device, one or more commands during a first transmission opportunity (TXOP). The method of this embodiment further includes transmitting an Extension command during the first TXOP and following the one or more commands, wherein the Extension command indicates that a tag access process is to continue in a second TXOP, and transmitting one or more additional commands during the second TXOP.

This second embodiment includes optional aspects. With one optional aspect, the method further includes receiving a confirmation from the tag device during the first TXOP in response to the extension command. In another optional aspect, the method of this embodiment further includes transmitting an excitation field at the beginning of the second TXOP, the excitation field including a carrier waveform having a repeated base waveform. In yet another optional aspect, the Extension command is compliant with an IEEE 802.11bp amendment to the IEEE 802.11 standard.

In another illustrative, non-limiting embodiment, an ambient power (AMP) compliant WiFi device includes one or more wireless transceivers and one or more processors operably coupled to the one or more wireless transceivers. The one or more processors are arranged to transmit, via the one or more wireless transceivers, one or more commands to a tag device during a first transmission opportunity (TXOP). The one or more processors of the WiFi device are further arranged to transmit, via the one or more wireless transceivers, an Extension command during the first TXOP and following the one or more commands, wherein the Extension command indicates that a tag access process is to continue in a second TXOP. In this embodiment, the one or more processors of the WiFi device are further arranged to transmit, via the one or more wireless transceivers, one or more additional commands during the second TXOP.

This third embodiment includes optional aspects. With one optional aspect, the one or more processors are further arranged to receive a confirmation from the tag device during the first TXOP in response to the Extension command. In another optional aspect, the second TXOP begins within a predetermined time period following the first TXOP. In another optional aspect, the predetermined time period is equal to or less than a short interframe space (SIFS). In a further optional aspect, the one or more processors are further arranged to transmit, via the one or more wireless transceivers, an excitation field at the beginning of the second TXOP, wherein the excitation field includes a carrier waveform having a repeated base waveform.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a processing core, processing circuitry, computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

As may be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may further be used herein, the term(s) “arranged to”, “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with” includes direct and/or indirect coupling of separate items and/or one item being embedded within another item.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processor”, “processing circuitry”, “processing circuit”, “processing module”, and/or “processing unit” may be a single processing device or a plurality of processing devices. Such a processing device may be a microprocessor, microcontroller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Further, such a processing device may include a plurality of processing cores or processing domains, which may operate on separate power domains. The processor, processing circuitry, processing circuit, processing module, and/or processing unit may be (or may further include) memory and/or an integrated memory element, which may be a single memory device, a plurality of memory devices, and/or embedded circuitry of another processor, processing circuitry, processing circuit, processing module, and/or processing unit. Such a memory device may be a read-only memory, random access memory, volatile memory, non-volatile memory, static memory, dynamic memory, flash memory, cache memory, and/or any device that stores digital information. Note that if the processor, processing circuitry, processing circuit, processing module, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processor, processing circuitry, processing circuit, processing module, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processor, processing circuitry, processing circuit, processing module, and/or processing unit executes, hard coded and/or operational instructions corresponding to at least some of the steps and/or functions illustrated in one or more of the figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the logic diagram block boundaries and sequence could have been defined otherwise and still perform the certain significant functionality. Such alternate definitions of both functional building blocks and logic diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors/processing cores executing appropriate software and the like or any combination thereof.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” may be used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for communicating with one or more tag devices by an ambient power (AMP) compliant WiFi device, the method comprising:
transmitting a CTS-to-Self (CTS2Self) frame, wherein the CTS2Self frame includes a duration field carrying a value indicating a wireless medium reservation duration for the AMP compliant WiFi device;
transmitting a first command;
receiving, in response to the first command, a reply from a tag device; and
transmitting, prior to the end of the wireless medium reservation duration, a CF-End frame to release a remaining portion of the wireless medium reservation duration.

2. The method of claim 1, wherein the first command is a Query command and the reply includes an identifier of the tag device.

3. The method of claim 2, further comprising:
transmitting, in response to receiving the reply from the tag device, an Acknowledge (ACK) frame; and
receiving data from the tag device in response to the ACK frame, wherein transmitting the CF-End frame follows receipt of the data.

4. The method of claim 2, wherein the identifier of the tag device is an RN16 value.

5. The method of claim 2, wherein the Query command indicates a random access parameter for multi-tag access.

6. The method of claim 5, wherein the random access parameter is a number of total slots.

7. The method of claim 6, wherein the tag device randomly selects a slot number of the number of total slots for transmitting the reply, and wherein the reply includes an identifier of the tag device.

8. The method of claim 5, further comprising:
determining that the reply from the tag device is invalid or missing; and
in response, transmitting a Query rep command.

9. The method of claim 8, further comprising:
receiving, in response to the Query rep command, an identifier of a second tag device;
determining that the identifier of the second tag device is valid; and
transmitting a second command for receipt by the second tag device, wherein the second command solicits data from the second tag device.

10. The method of claim 1, wherein the first command is a Write command or an Authenticate command.

11. The method of claim 1, further comprising:
transmitting, during the wireless medium reservation duration, a second command; and
receiving, in response to the second command, a reply from a second tag device.

12. The method of claim 1, wherein the first command is transmitted during a first transmission opportunity (TXOP), the method further comprising:
transmitting a second command in a predetermined time period following the first TXOP.

13. The method of claim 12, wherein the predetermined time period is equal to or less than a short interframe space (SIFS), and wherein the AMP compliant WiFi device does not transmit a second CTS2Self frame prior to transmitting the second command.

14. A method for reading data from a tag device, the method comprising:
transmitting, by an ambient power (AMP) compliant WiFi device, one or more commands during a first transmission opportunity (TXOP);
transmitting an Extension command during the first TXOP and following the one or more commands, wherein the Extension command indicates that a tag access process is to continue in a second TXOP; and
transmitting one or more additional commands during the second TXOP.

15. The method of claim 14, further comprising:
in response to the extension command, receiving a confirmation from the tag device during the first TXOP.

16. The method of claim 14, further comprising:
transmitting an excitation field at the beginning of the second TXOP, the excitation field including a carrier waveform having a repeated base waveform.

17. The method of claim 14, wherein the Extension command is compliant with an IEEE 802.11bp amendment to the IEEE 802.11 standard.

18. An ambient power (AMP) compliant WiFi device, comprising:
one or more wireless transceivers; and
one or more processors operably coupled to the one or more wireless transceivers, wherein the one or more processors are arranged to:
transmit, via the one or more wireless transceivers, one or more commands to a tag device during a first transmission opportunity (TXOP);
transmit, via the one or more wireless transceivers, an Extension command during the first TXOP and following the one or more commands, wherein the Extension command indicates that a tag access process is to continue in a second TXOP; and
transmit, via the one or more wireless transceivers, one or more additional commands during the second TXOP.

19. The AMP compliant WiFi device of claim 18, wherein the one or more processors are further arranged to:
in response to the Extension command, receive a confirmation from the tag device during the first TXOP.

20. The AMP compliant WiFi device of claim 18, wherein the second TXOP begins within a predetermined time period following the first TXOP.

21. The AMP compliant WiFi device of claim 20, wherein the predetermined time period is equal to or less than a short interframe space (SIFS).

22. The AMP compliant WiFi device of claim 18, wherein the one or more processors are further arranged to:
transmit, via the one or more wireless transceivers, an excitation field at the beginning of the second TXOP, wherein the excitation field includes a carrier waveform having a repeated base waveform.
